(19) United States
(12) Patent Application Publication
(10) Pub. No.: US 2017/0138259 A1
(43) Pub. Date: May 18, 2017

(54) GAS TURBINE GENERATOR COOLING

(71) Applicant: Siemens Aktiengesellschaft, München (DE)

(72) Inventor: UWE JURETZEK, ERLANGEN (DE)

(21) Appl. No.: 15/317,130

(22) PCT Filed: Apr. 30, 2015
(86) PCT No.: PCT/EP2015/059464

§ 371 Date: Dec. 8, 2016

(30) Foreign Application Priority Data
Jun. 17, 2014 (DE) 10 2014 211 590.6

(51) Int. Cl. F02C 6/08; F02C 7/18; F01D 15/10; F02C 3/04

(52) U.S. Cl. CPC F02C 6/08; F02C 3/04; F02C 7/18; F01D 15/10; F05D 2220/32; F05D 2240/35; F05D 2260/213

(57) ABSTRACT

A gas turbine system with a compressor, a combustion chamber, a turbine, and a generator which is driven by the turbine is provided. A cooling air line is connected to a housing of the generator, wherein cooling air can be supplied to the interior of the generator via the cooling air line. The gas turbine system is characterized in that the cooling air line is connected to the compressor on the inlet side, and at least one heat exchanger and an expander, in particular a turboexpander, are arranged in the cooling air line one behind the other. In order to cool the generator, precompressed air is branched out of the compressor via the cooling air line, cooled in the heat exchanger, and expanded in the expander while being further cooled before being supplied to the interior of the generator.

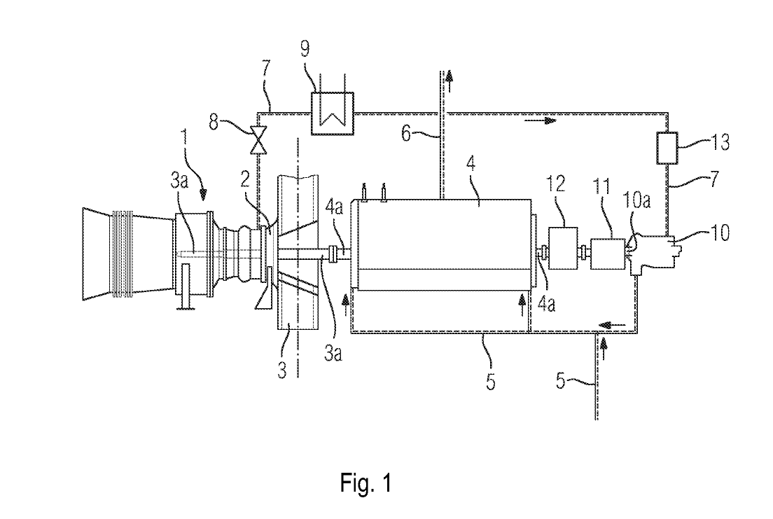

### CROSS-REFERENCE TO RELATED APPLICATIONS

This application claims priority to PCT Application No. PCT/EP2015/059464, having a filing date of Apr. 30, 2015, based off of DE Application No. 10 2014 211 590.6 having a filing date of Jun. 17, 2014, the entire contents of which are hereby incorporated by reference.

### FIELD OF TECHNOLOGY

The following relates to a gas turbine plant having a compressor, a combustion chamber, a turbine and a generator that is driven by the turbine, wherein a cooling air line, via which cooling air can be supplied to the interior of the generator, is connected to a casing of the generator. The following also relates to a method for operating a gas turbine plant having a compressor, a combustion chamber, a turbine and a generator that is driven by the turbine, wherein cooling air is supplied to the generator.

### BACKGROUND

In a turbomachine, for example in a gas turbine, the expansion of inflowing hot process fluid, e.g. a hot gas, is used to obtain work.

Gas turbine plants always comprise an air inlet, a compressor section, a combustion chamber and a turbine section. The compressor section can consist or include of axial-flow or radial-flow compressors. Axial-flow compressors generally consist or include of multiple rotors having compressor blades in an axial arrangement, these being commonly split into low-pressure and high-pressure compressor stages. The compressor section imparts kinetic energy to the inflowing air mass, which is converted into pressure energy in the diffuser-shaped interspaces between the compressor blades. According to Bernoulli's principle, in a duct of increasing cross section area, the static pressure increases while the flow speed decreases. The lost kinetic energy is again imparted in a rotor stage. Therefore, a complete compressor stage of an axial-flow compressor consists of a rotor stage, in which pressure, temperature and speed increase, and a stator stage in which the pressure rises at the expense of the speed.

In the combustion chamber, the air which is compressed and heated (due to compression) is mixed with a fuel, and the resulting fuel-air mixture is burnt. The exothermic reaction causes another sharp increase in temperature, and the gas expands. This results in a hot gas which is expanded in the subsequent turbine section, thermal energy being converted into mechanical energy, part of which is used to drive the compressor section, the remainder being used to drive a generator or the like.

Raising the efficiency of a gas turbine plant involves, inter alia, attempting to achieve as high as possible a temperature of the hot gas. This means that those components that are directly exposed to the hot gas are subject to particularly high thermal loading. In the case of a gas turbine, this relates for example to the blading in the turbine and to those wall elements of the turbine that bound the hot gas flow space. For that reason, those components that are exposed to the hot gas are provided with costly thermal barrier systems which are intended to protect in particular the turbine blades from the hot gas. In addition, those components that are exposed to the hot gas are cooled. What is known as film cooling is one example of a proven option for cooling turbine blades. In that context, pre-compressed air as coolant is extracted from the compressor of the gas turbine plant and is fed to the interior of the hollow turbine blades in order to cool these from the inside. The cooling air then passes through corresponding cooling fluid channels, that pass through the wall of the turbine blades, to the outer surface of the turbine blades, where it forms a cooling film that is intended to protect the turbine blades from direct contact with the hot gas.

The power produced by the generator of the gas turbine plant is also dependent on the permissible internal heating of the generator components. What are referred to as insulation classes limit the absolute value of temperatures. It is conventional to use class B or F, which corresponds to a permissible component temperature of 130° C. or, respectively, 155° C. Exceeding the permissible component temperature results in accelerated aging of the component, and thus to a reduced service life. In order to cool the generator, provision can be made, for example, of open air cooling (OAC), in which ambient air is drawn in, fed through the generator components that are to be cooled, and is given off, heated, back to the environment. Colder ambient air makes it possible, by virtue of the increased temperature difference between the cooling air and the permissible component temperature, to increase the electrical power output of the generator without exceeding the permissible component temperatures. As is desirable, it is thus possible for the generator to follow a gas turbine power that also increases with lower ambient air temperature. It is also known, for example from WO 2004/017494 A1, to equip generators with a closed cooling circuit. In this context, the cooling air circulated in a closed circuit is cooled in a generator cooler using a cooling water circuit, wherein the temperature of the cooling water is additionally lowered in a refrigeration unit prior to entry into the generator cooler. In that context, the cooling gas temperature established in the generator is assigned a corresponding maximum possible apparent power of the generator.

In particular as a consequence of the development of gas turbine technology and power increases based thereon, it can occur that the apparent power of the generator originally coupled to the gas turbine is too low (for a given cooling value temperature) to be able to cover the increasing active power (increased shaft power of the gas turbine) while still providing sufficient reactive power. Thus, the sale of gas turbine upgrades is bound up with boosting the efficiency of or possibly even replacing the generator, which impairs the cost-effectiveness.

### SUMMARY

An aspect relates to a gas turbine plant of the type mentioned in the introduction, with an improved generator cooling system.

According to embodiments of the invention, this aspect is achieved, in the context of a gas turbine plant of the type mentioned in the introduction, in that the inlet side of the cooling air line is connected to the compressor, and at least one heat exchanger and an expander, in particular a turboexpander, are arranged in series in the cooling air line, wherein for cooling the generator pre-compressed air is diverted from the compressor via the cooling air line, is cooled in the heat exchanger and is expanded in the expander, cooling further, before it is fed into the generator.

In the case of a method of the type mentioned in the introduction, the above-mentioned aspect is accordingly achieved in that, in order to generate the cooling air, pre-compressed air is extracted from the compressor and the pre-compressed air is cooled in a heat exchanger and is subsequently expanded in an expander, cooling further, before it is fed to the generator.

According to embodiments of the invention, a small part of the already-compressed air is diverted in order to improve the generator cooling. This compressed air, which is still hot, is cooled by means of a heat exchanger and is expanded in an expander, in particular a turboexpander, to “generator pressure”, and in the process uses the energy contained in the compressed air. This further cools the air. As a result, the air supplied to the generator provides cooling power that makes it possible to adequately cool the generator components such that their temperature is held below a desired permissible temperature.

The following is thus based on the consideration of coupling the compressor of the gas turbine plant to the heat exchanger or heat exchangers that is/are provided according to embodiments of the invention for giving off heat, to the expander and to the generator to give a compressor refrigeration machine using air as its working medium. In that context, the air is guided in an open circuit, that is to say that after flowing through the generator it is discharged to the environment through an appropriately large generator waste air duct. This prevents an increase of pressure in the generator housing.

The advantage of the solution according to embodiments of the invention lies in an increased apparent power of a given air-cooled generator by lowering the cooling gas temperature. This is far beyond the possibilities that can be achieved by reworking normal heat removal systems, which simply give off their heat to the environment and are thus limited.

The improved cooling and the increase in apparent power that is possible thereby can be provided temporarily, i.e. only when there is a correspondingly high power demand on the generator, or else permanently.

The refrigeration machine concept according to embodiments of the invention is particularly well-suited to the retrofitting business, but there are cost advantages also for new plants since it may be possible to avoid having to make the leap to a substantially more expensive, for example hydrogen-cooled, generator.

Also advantageous is that, with relatively low outlay, it is possible to boost the efficiency of an existing generator which thus, for example, no longer limits a power increase of the gas turbine. This involves sending only a relatively small quantity of air to exactly those regions of the generator that require better cooling. This can in particular be the generator rotor. It is however also possible to provide larger quantities of cooling air using the configuration according to embodiments of the invention.

In particular, the cooling system also makes it possible to complement an already-present direct cooling system using ambient air, which has its strengths at low ambient air temperatures, such that the cooling system provided according to embodiments of the invention need be switched on only at peak loads.

In that context, the cooling air can be mixed with the ambient air prior to entry into the generator. Alternatively, the cooling air can be fed, via corresponding cooling air lines (ducts, pipes), to only those regions of a generator that require particular cooling.

As a guideline value, one can assume that, in the case of large air-cooled generators, each degree Celsius drop in the cooling gas temperature results in approximately 2 MVA of additional apparent power. The ultimate gain in apparent power is dependent on how much additional cooled air should be provided. Overall, however, it should be possible to obtain up to 30-40 MVA, even in the case of otherwise poor re-cooling conditions due to high ambient or cooling water temperatures, with acceptable losses.

According to one embodiment of the invention, it is provided that the cooling air line is assigned an inlet valve via which the quantity of air diverted from the compressor is set, in particular in dependence on the cooling power to be made available to the generator.

In order that the heat extracted in the heat exchanger from the air diverted from the compressor is not given off only to the environment, which would reduce efficiency, it is provided according to a preferred embodiment of the invention that the cold side of the heat exchanger is connected to a combustion gas supply line via which the combustion chamber is supplied with a combustion gas in order to preheat the combustion gas in the heat exchanger. This configuration is considered particularly advantageous since increasing gas turbine power is directly associated with increasing combustion gas mass flow and in that regard the removal of heat directly follows the increasing generator cooling requirement in the context of increasing power. Alternatively, it is also possible to supply the heat extracted from the air in the heat exchanger to the steam circuit of a combined cycle power plant. For example, the steam condensate can be heated prior to entry into a condensate pre-heater. It is also possible to heat the intermediate-pressure feed water in the heat exchanger.

The expander can lie on the same shaft as the generator in order to drive the latter. In that context, the expander can be connected to the generator shaft, in particular via a synchro-self-shifting (SSS) clutch, via which the expander is automatically coupled to the generator when the shaft speed of the expander shaft reaches the speed of the generator shaft. This configuration also has the advantage that the generator cooling system can easily be switched on or off as required.

It is also possible for the expander to be connected to an additional secondary generator in order to drive the latter. By determining an appropriately low compressor bleed pressure and/or an appropriately high temperature of the air prior to expansion in the expander, it is possible to ensure that the temperature of the supplied air does not drop below the dew point after expansion. If the air temperature is to be lowered beyond this, or if the air is additionally humidified, in particular prior to or during compression in the compressor, then the air must be dehumidified prior to expansion, lest there be undesirable formation of water or, below 0° C., ice. For this case, according to one embodiment of the invention there is provided, at the heat exchanger or between the heat exchanger and the expander, a dehumidifier which extracts the excess moisture from the air at the heat exchanger for heat reduction, or prior to entry into the expander.

The cooling technology according to embodiments of the invention is in principle also suitable for steam turbine generators that are part of a combined cycle (CCGT) power plant. The low required quantity of compressor air allows the gas turbine to also supply the steam turbine generator with cooling air. In this case, part of the cooling air exiting the expander is supplied to the generator of the steam turbine. This generator would then also have to be equipped with an appropriate waste air duct in order to avoid a pressure increase within the generator housing.

Furthermore, connecting the expander to the generator shaft by means of a SSS clutch is relatively compact and hence advantageous.

### BRIEF DESCRIPTION

Some of the embodiments will be described in detail, with reference to the following figures, wherein like designations denote like members, wherein:

The FIGURE is a gas turbine plant in accordance with an embodiment of the present invention.

### DETAILED DESCRIPTION

There follows a discussion of an embodiment of a gas turbine plant according to embodiments of the invention, with reference to the drawing. In the drawing, the single FIGURE shows, schematically, the exemplary embodiment of the gas turbine plant according to embodiments of the invention. This gas turbine plant comprises a compressor 1, a combustion chamber 2, a gas turbine 3 and a generator 4, all of conventional design. In that context, the compressor 1 lies on a turbine shaft 3a of the gas turbine 3 such that the compressor 1 is driven by the gas turbine 3. Furthermore, the turbine shaft 3a is connected to a generator shaft 4a in order to drive the generator 4.

The generator 4 is equipped with an air cooling system that operates according to the principle of open air cooling, in which the interior of the generator 4 is supplied with cooling air, that is taken from the surroundings, is fed through an inflowing air line 5 and, after flowing through the generator 4, is discharged via a waste air duct 6 back to the environment.

Connected to the inflowing air line 5 is a cooling air line 7 whose inlet is connected, via an inlet valve 8, to the compressor 1 of the gas turbine plant. A heat exchanger 9 and a turboexpander 10 are arranged in series in the cooling air line 7. Here, the heat exchanger 9 is shown by way of example, but it is also possible for multiple series-connected heat exchangers to be provided. The inlet valve 8 allows pre-compressed air to be taken from the compressor 1, which air is then cooled in the heat exchanger 9 and is expanded in the turboexpander 10, cooling further. This makes it possible to provide relatively low-temperature cooling air which is mixed, in the inflowing air duct 5, with the ambient air in order to increase the available cooling power. Particularly advantageously, this cooling air is not mixed with the ambient air in the inflowing air duct but is sent, in a very targeted manner via suitable cooling air lines (ducts, pipes), to only those regions of the generator that require particular cooling. In that context, the quantity of admixed cooling air can be set using the inlet valve 8. It is in particular also possible to generate cooling air, using the heat exchanger 9 and the expander 10, only when required.

In the exemplary embodiment shown, the expander shaft 10a of the turboexpander 10 is connected, via a synchro-self-shifting (SSS) clutch 11 and an exciter 12 assigned to the generator 4, to the generator shaft 4a in order to drive the generator and thus use the energy released in the turboexpander 10.

The Figure shows, only schematically, that there is provided, in the cooling air line 7 between the heat exchanger 9 and the turboexpander 10, a dehumidifier 13 by means of which, if required, moisture can be removed from the air cooled in the heat exchanger 9. A dehumidification device can also be assigned to the heat exchanger 9 itself, in order to directly remove, from the air, air humidity or condensate produced during the release of heat.

During operation of the gas turbine plant, intake air is compressed in the compressor 1. In the combustion chamber 2, the air which is compressed and heated (due to compression) is mixed with a fuel, and the resulting fuel-air mixture is burnt. The exothermic reaction causes another sharp increase in temperature, and the gas expands. This results in a hot gas which is expanded in the subsequent gas turbine 3, thermal energy being converted into mechanical energy which is used on one hand to drive the compressor 1, the remainder being used to drive the generator 4. The generator is cooled using ambient air that is supplied to the interior of the generator 4 via the inflowing air line 5, and is removed again to the environment via the waste air duct 6. If the cooling that can be achieved using the ambient air is not sufficient, pre-compressed air at a pressure of 1.5 to 3 bar is extracted from the compressor 1, via the cooling air line 7, by actuation of the inlet valve 8. In that context, the quantity of extracted cooling air can be set using the inlet valve 8 according to the required cooling power. The air extracted from the compressor 1 is cooled in the heat exchanger 9, possibly dried in the dehumidifier 13, and then expanded in the turboexpander 10, cooling further, so as to provide low-temperature cooling air that is admixed to the ambient air in the inflowing air line 5 or is made available in a targeted manner, via suitable cooling air lines (ducts, pipes), to those points in the generator requiring particular cooling.

If the speed of the expander shaft 10a of the turboexpander 10 matches the speed of the generator shaft 4, the two shafts 4a, 10a are connected to one another via the clutch 11 such that the generator 4 is (co-)driven by the turboexpander 10.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-12. (canceled)

13. A gas turbine plant comprising:
a compressor, a combustion chamber, a turbine and a generator that is driven by the turbine, wherein a cooling air line, via which cooling air can be supplied to the interior of the generator, is connected to a casing of the generator, wherein the inlet side of the cooling air line is connected to the compressor, and at least one heat exchanger and a turboexpander, which are arranged in series in the cooling air line, wherein for cooling the generator pre-compressed air is diverted from the compressor via the cooling air line, is cooled in the heat exchanger and is expanded in the expander, cooling further, before it is fed into the generator, the expander is connected to the generator in order to drive the latter.

14. The gas turbine plant as claimed in claim 13, wherein the cooling air line is assigned an inlet valve via which the quantity of air diverted from the compressor is set, in dependence on the cooling power to be made available to the generator.

15. The gas turbine plant as claimed in claim 13, wherein the cold side of the heat exchanger is connected to a combustion gas supply line via which the combustion chamber is supplied with a combustion gas in order to preheat the combustion gas in the heat exchanger.

16. The gas turbine plant as claimed in claim 13, wherein the expander is connected to the generator via a synchro-self-shifting clutch.

17. The gas turbine plant as claimed in claim 13, wherein the expander is connected to an additional secondary generator in order to drive the latter.

18. The gas turbine plant as claimed in claim 13, wherein there is provided, between the heat exchanger and the expander, a dehumidifier in order to extract moisture from the air cooled in the heat exchanger, prior to entry into the expander.

19. A method for operating a gas turbine plant having a compressor, a combustion chamber, a turbine and a generator that is driven by the turbine, comprising the steps of supplying cooling air to the generator, in order to generate the cooling air, extracting pre-compressed air from the compressor and cooling the pre-compressed air in a heat exchanger and subsequently expanding the pre-compressed air in an expander, and cooling further, before the expanded air is fed to the generator.

20. The method as claimed in claim 19, wherein the air extracted from the compressor is dried prior to expansion in the expander.

21. The method as claimed in claim 19, wherein the cooling air expanded in the expander is fed in a targeted manner to only those points in the generator that require particular cooling.

22. The method as claimed in claim 19, wherein before entering the generator, the cooling air expanded in the expander is mixed with ambient air that is supplied to the generator.

23. The method as claimed in claim 19, wherein part of the cooling air exiting the expander is supplied to the generator of a steam turbine.
